(19) United States
(12) Patent Application Publication
(10) Pub. No.: US 2007/0140444 A1
(43) Pub. Date: Jun. 21, 2007

(54) Proxy response terminal and system

(75) Inventors: Kazuma Yumoto, Fuchu (JP); Tatsuhiko Miyata, Kokubunji (JP); Masahiro Yoshizawa, Kokubunji (JP); Hiroshi Kodaka, Chigasaki (JP)

Correspondence Address: Stanley P. Fisher;Reed Smith LLP, Suite 1400, 3110 Fairview Park Drive, Falls Church, VA, 22042-4503, US

(73) Assignee: Hitach, Ltd.

(21) Appl. No.: 11/496,634

(22) Filed: Aug. 1, 2006

(30) Foreign Application Priority Data
Dec. 20, 2005 (JP) 2005-365691

(51) Int. Cl. H04M 1/64

(52) U.S. Cl. 379/88.21

(57) ABSTRACT

A proxy response terminal wherein information relating to the call being called is acquired and the call to which a proxy response is to be made is expressly specified so that the call may be responded. The proxy response terminal includes an incoming information acquiring means for requesting the information relating to the call in the calling state to the call control apparatus and a proxy response requesting means for issuing connection request specifying the call to which a proxy response is to be made based on the information notified by the call control apparatus. And the call control apparatus includes an incoming information notifying means for notifying the information relating to the call in the calling state at a terminal in the group to which the proxy response terminal belongs in response to an incoming information acquiring request presented by the proxy response terminal, and a call controlling means for relaying the connection request presented by the calling terminal and the proxy response request presented by the proxy response terminal.

### CLAIM OF PRIORITY

The present application claims priority from Japanese application JP 2005-365691 filed on Dec. 20, 2005, the content of which is hereby incorporated by reference into this application.

### FIELD OF THE INVENTION

The present invention relates to an art that enables to identify to whom incoming calls are addressed in connection with proxy responses that may be made to the incoming calls to other telephone apparatuses.

### BACKGROUND OF THE INVENTION

In the past, businesses corporations often respond to telephone calls in the form of proxy response when the telephone apparatus of the post to which the callee is affected is ringing, even if the call is not addressed to the telephone apparatus on the callee's desk, and the PBX (Private Branch exchange) or the telephone apparatus has a function to execute the proxy response.

On the other hand, as a means for conveying the information relating to the caller to the callee at the time of reception, a caller number notifying function has been introduced. The caller number notifying function notifies the telephone number of the caller to the callee by displaying the same on the callee's telephone apparatus.

An example of receiving proxy response sequence in the IP telephone system is shown in the JP 2002-152224A or the JP 2004-235778 A.

### SUMMARY OF THE INVENTION

The prior caller number notifying function could notify the caller's telephone number to the receiving terminal or the callee. However, it was impossible to obtain the information relating to the caller by using the terminal used to carry out the proxy response before the telephone communication.

The issue that the present invention is trying to solve is to enable the terminal used to carry out proxy responses to obtain the information relating to the caller and the information relating to the callee.

As a means for solving the issue described above, the proxy response terminal according to the present invention has an incoming information acquiring means for requesting the information relating to the call in the calling state on a terminal within the group to which the proxy response terminal belongs from the call control apparatus.

And the call control apparatus according to the present invention has an incoming information notifying means for notifying the information relating to the call in the calling state on a terminal within a group to which the proxy response terminal belongs upon receiving an incoming information acquiring request from the proxy response terminal.

In addition, the proxy response terminal has a proxy response requesting means for issuing a connection request specifying the call chosen for proxy response based on the information notified by the call control apparatus as a response to the incoming information acquiring request.

And the call control apparatus has a call controlling means for relaying the proxy response requests from the proxy response terminal and the connection requests from calling terminal and for handling a communication with the proxy response terminal and the calling terminal as a call.

### [Effect of the Invention]

The incoming information acquiring means that the proxy response terminal has and the incoming information notifying means that the call control apparatus has enable the terminal chosen to execute a proxy response to provide the proxy responder with information on the caller. As this enables the proxy responder to estimate the caller before starting the communication, it will be possible to judge definitively whether a proxy response should be made or not.

And when a plurality of incoming calls are received at the same time, the incoming information notifying means can be used to convey all the plurality of incoming call information within the group, and the proxy response requesting means that the proxy response terminal has can be used to cope with the same by specifying the calls to which proxy response will be carried out. This will enable the proxy responder to identify the caller and the callee of a call in the midst of the call being made even if a plurality of incoming calls is received within the group. As a result, it will be possible to respond by selecting calls having a high priority.

Furthermore, the call controlling means that the call control apparatus has can be used to connect the connection request calls from the caller terminal and the proxy response calls from the proxy response terminal. This will enable to make efficient use of the prior terminals as they are without adding any special functions to the calling terminal for coping with proxy responses.

### BRIEF DESCRIPTION OF THE DRAWINGS

FIG. 1 is a diagram showing an example of configuration of the proxy response system according to the present invention;

FIG. 2 is a diagram showing an example of configuration of a proxy response terminal;

FIG. 3 is a diagram showing an example of configuration of a call control apparatus;

FIG. 4 is a sequence diagram showing an example of connecting procedure at the time of proxy response;

FIG. 5 is a flowchart showing an example of processing procedure at the time of proxy response at the proxy response terminal;

FIG. 6 is a flowchart showing an example of processing procedure at the time of proxy response at the call control apparatus;

FIG. 7 is a table illustration showing an example of the terminal control table of the call control apparatus;

FIG. 8 is a table illustration showing an example of the session control table of the call control apparatus; and

FIG. 9 is an illustration showing an example of the physical image of the proxy response terminal.

### DETAILED DESCRIPTION OF THE PREFERRED EMBODIMENTS

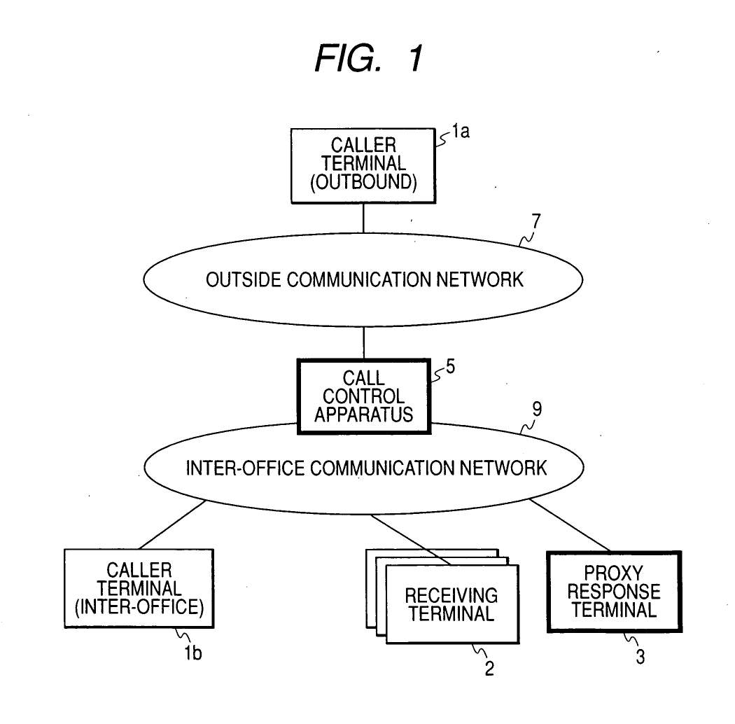

FIG. 1 is a diagram showing an example of the constitution of the proxy response system according to the present invention. The caller terminal 1 takes two different forms depending on whether the call is made for outside communication 1a or for inter-office communication 1b. The caller terminal for inter-office communication 1b is connected with the inter-office communication network 9 in the same way as the receiving terminal 2 or the proxy response terminal 3. On the other hand, the caller terminal for outside communication 1a calls the receiving terminal 2 connected with the inter-office communication network 9 through the call control apparatus 5 from the outside communication network 7. The call control apparatus 5 manages the calling and receiving of the terminals connected with the inter-office communication network 9 and controls the relay of call control messages. The communication network may be either a circuit switching network or a packet switching network. However, if the inter-office communication network 9 is a packet switching network, and the outside communication network 7 is a circuit switching network, the call control apparatus 7 plays the role of a gateway apparatus also. In the case of a packet switching network, the communication of voice data and other non-calling control messages is normally directly transmitted and received between the terminals. However, in the case of sending and receiving data with a circuit switching network and between a circuit switching network and a packet switching network, a call control apparatus 5 having the gateway function relays the data.

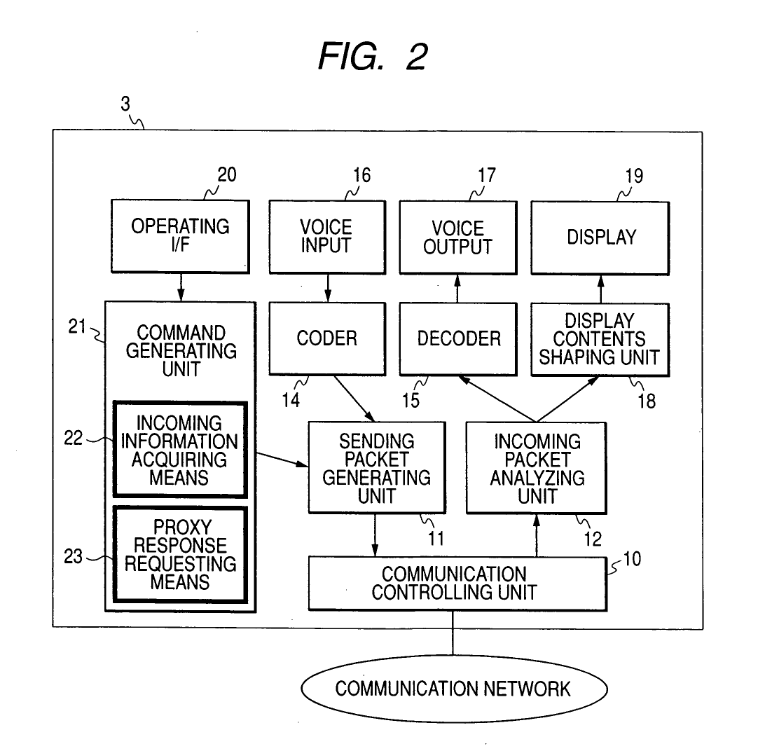

FIG. 2 is a diagram showing an example of configuration of proxy response terminal. The proxy response terminal 3, which may be either in the form of a telephone apparatus or a softphone that works on a PC or the like, has the following functions. As a user interface, it has a voice input interface 16 having a function corresponding to a microphone, a voice output interface 17 having a function corresponding to a speaker, a display 19 displaying the incoming information, and an operating interface 20 accepting dial input or key input. Messages and data are transmitted and received between the communication networks through the communication controlling unit 10. The voice inputted from the voice input interface 16 is codified by a coder 14, shaped into a communicable form by the sending packet generating unit 11 and is transmitted from the communication controlling unit 10. On the other hand, the packet received by the communication controlling unit 10 is analyzed by the type of contents by the incoming packet analyzing unit 12, and in the case of voice data, the data are decoded into waveform information by the decoder 15, and are outputted from the voice output interface 17.

A series of operations such as on hook, off hook, dial operation and the like are inputted through the operating interface 20, replaced by the corresponding commands by the command generating unit 21, shaped into communicable form by the sending packet generating unit 11 and are outputted from the communication controlling unit 10.

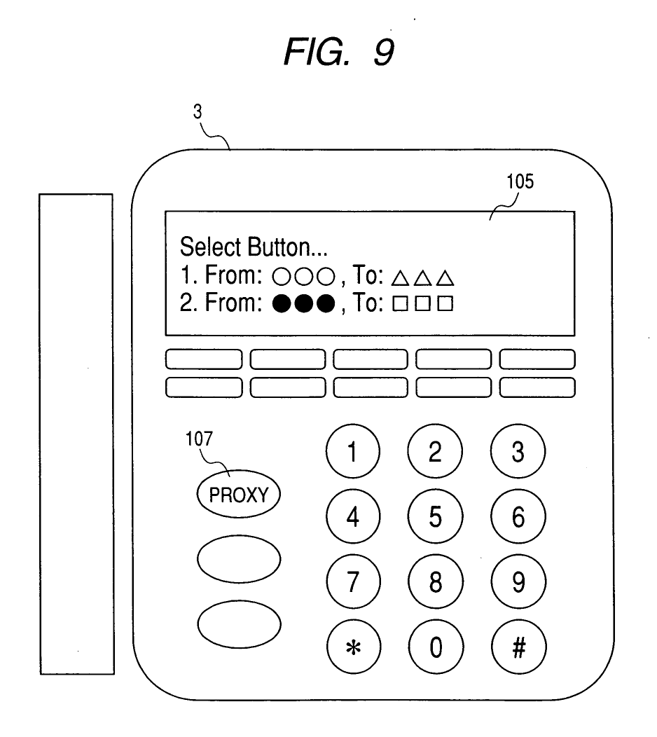

FIG. 9 is an illustration showing an example of the physical image of a proxy response terminal. To carry out a proxy response, for example, the proxy response button 107 (a part of the operating interface 20) is pushed to request the acquisition of information relating to the incoming data from the terminals within the group in the calling state. This request is replaced by a corresponding command (for example, a request for SUBSCRIBE to the terminals belonging to the group) by the incoming information acquiring means 22 in the command generating unit 21, shaped into a communicable form by the sending packet generating unit 11 to be sent out by the communication controlling unit 10.

As a result, the incoming information notified by the call control unit 5 passes through the communication control unit 10 and the incoming packet analyzing unit 21, reaches the display contents shaping unit 18 to be displayed by the display 19. This display example is shown as an example in 105 of FIG. 9.

To carry out a proxy response after confirming the incoming information, for example, the numeral button corresponding to the call for proxy response is pressed, and then the proxy response button 107 is pressed again. This request is replaced by the corresponding command (for example, a REPLACE request and the like) by the proxy response requesting means 23 within the command generating unit 21 in the same way as the incoming information acquiring means, shaped into a communicable form by the sending packet generating unit 11 to be sent out from the communication controlling unit 10.

Although the description of this mode of carrying out mentions the calling terminal, the receiving terminal and the proxy response terminal by differentiating them respectively, the structure of providing a same terminal with various terminal functions may be adopted.

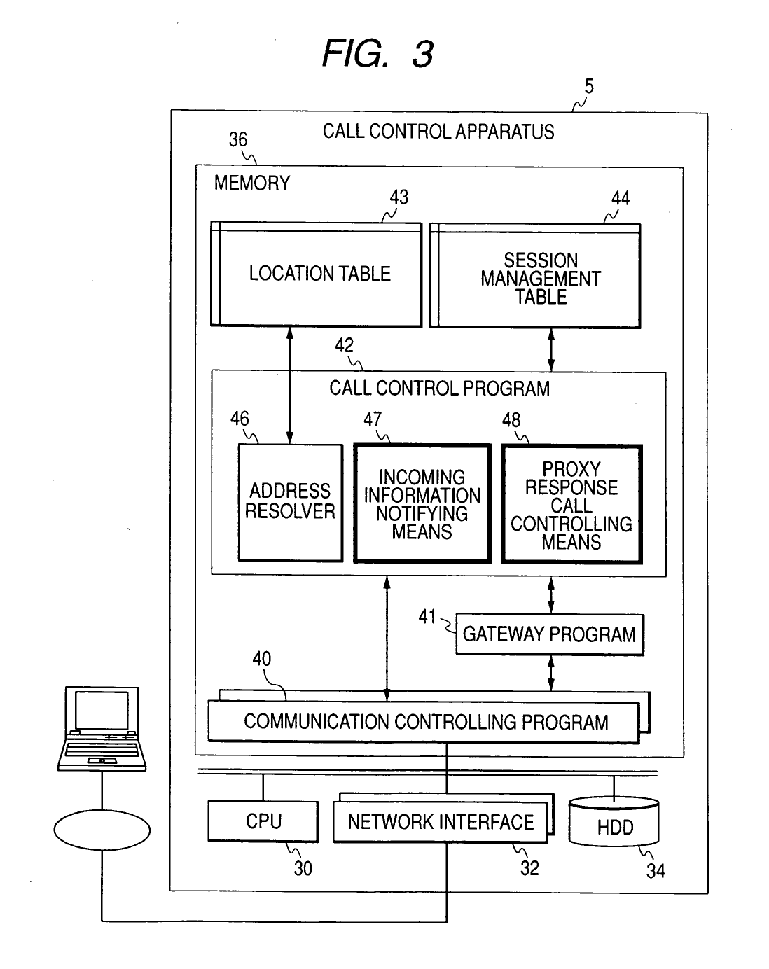

FIG. 3 is a diagram showing an example of configuration of a call control apparatus. The call control apparatus 5 includes a CPU (30), a memory (36), a storage device (34) and a network interface (32) and stores a control program described in details below. The control program of the call control apparatus stored in the storage device is deployed on the memory at the time of operation and is executed by the CPU. The storage device may be mounted in the enclosure, or may be installed in a different enclosure as an outside storage device, or may be connected by a network. It may also include a user interface for enabling the user having the power of managing the apparatus to operate the call control apparatus. The user interface may be, for example, a keyboard for inputting commands, a mouse for inputting GUI, a display screen and the like.

The control program includes a communication control program 40, a gateway program 41, a call control program 42, a terminal control table 43, and a session control table 44.

The communication control program 40 analyses the packet received through the network interface 32, shapes the header information required for sending the packet and sends the same.

The gateway program 41 represents the so-called VoIP (Voice over IP) gateway or IP-PBX function, converts the protocols between the circuit switching network and the packet switching network, and even in the case of communication protocols of the same packet switching, converts different protocols such as H. 323 and SIP (Session Initiation Protocol) so that communications may be made mutually.

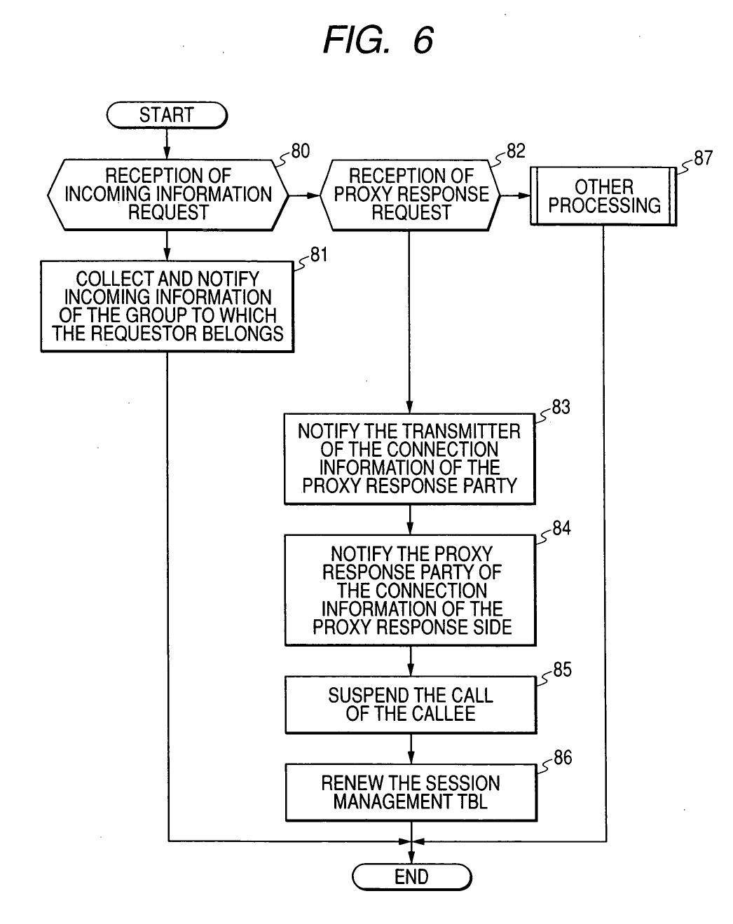

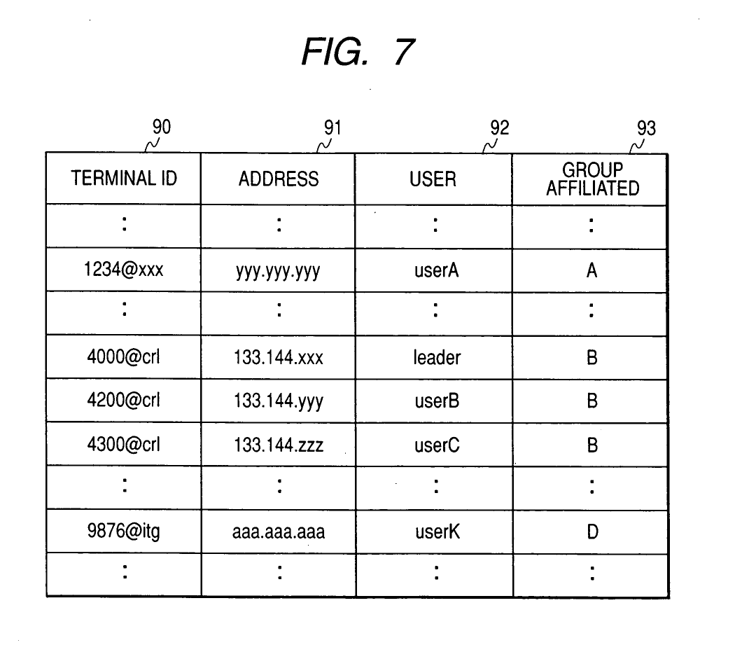

The call control program 42 mainly solves addresses and relays the connection control messages issued by terminals, and at the same time is the main constituent element of the call control apparatus 5 for managing the calling state. Although the prior functions of the call control program are omitted in the figure, one of the representative functions is an address solution program 46 used in solving the addresses. The address solution program 46 solves the addresses of the address terminal by referring the information contained in the terminal control table 43 as shown in FIG. 7. In the present invention, the terminal control table 43 and the address solution program 46 are used not only for solving addresses but also for solving the users of the terminal and the groups belonging to the terminal. The detailed flow of operations will be described for the description of FIG. 6.

In addition, in order to realize the proxy response function of the present invention, the call control program 42 includes an incoming information notifying means 47 and a call controlling means for addressing to proxy responses 48.

FIG. 7 is a table showing an example of the terminals control table. The terminals control table 43 manages location information such as the terminal IDs (90) and contact addresses 91 (for example “IP addresses”) managed by the call control apparatus. For the terminal IDs (90), telephone numbers and the identifiers of SIP, URI and the like are used. The contact addresses 91 may be registered fixedly by the manager for their use or may be dynamically reflected by the registration notices from terminals. And the validity term of registration may be managed by a timer.

And in the terminals control table 43, the terminal user information 92 and the information on what group the terminal belongs 93 are managed by correlating the same with the terminal IDs through the registration work of the manager. However, the contact addresses 91, the user information 92 and the information on what group the terminal belongs 93 may be managed respectively by separate table because what is required is the relationship of correspondence with the respective terminal ID (90). And the management table may be divided in block of group to which the terminals belong.

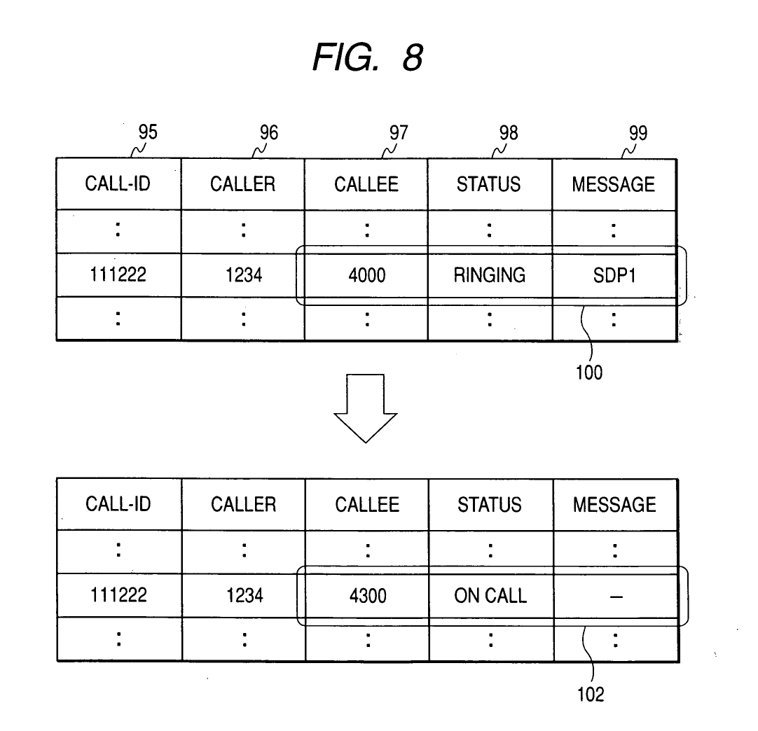

FIG. 8 is a table showing an example of the session control table 43. The session control table 44 manages changes in the state of each call. In the case of the SIP system, Call ID (95) is used for the identifier of call, and manages the state of each call (98) by linking the same with the caller information (96) and the callee information (97) and by forming pairs. For the caller information and the callee information, identifiers such as telephone number, SIP-URI and the like are used. And during the period ending with the establishment of a call, the message contents included in the calling message (for example, SDP: Session Description Protocol) and the like are recorded in parallel.

The session control table 44 and the local location table 43, which are described in FIG. 3 as tables on the memory 36, may be a data base table placed on the storage device 34. And the terminals control table may be kept in outside DB (data base) instead of keeping the same in the call control apparatus and this DB may be accessed whenever it is necessary. However, in order to accelerate the relay processing of call controlling messages, it is more advantageous to keep the information on the terminals to which the user responds himself or herself in the user's own server in the form of a terminal control table 44 than to refer always the outside DB. The same thing can be said for the session control table.

FIG. 6 is a flowchart showing an example of processing procedure for carrying out a proxy response in the call response apparatus. When the received message is an incoming information request sent from a proxy response terminal 3 (step 80), the incoming information notifying means 47 in the call control program 42 is executed. The incoming information notifying means 47 extracts the terminals of the group specified in the incoming information request message received or other terminals of the group to which the proxy response terminal having issued the incoming information request message belong by referring the terminals control table 43. Then, it confirms the calling state of the extracted terminals by referring the session control table 44. At this stage, if the state of call (98) is calling (ringing), information relating to calls in the calling state (ringing) such as call ID (95), caller information (96), callee information (97) and the like is notified to the proxy response terminal 3 (step 81).

Then, if the received message turned out to be a proxy response request sent from a proxy response terminal 3 (step 82), the call controlling means responding to proxy response 48 in the call control program 42 is executed. The call controlling means responding to proxy response 48 searches the session control table 44 by using the identifier of the proxy response call specified in the proxy response request message as a search key, and answers by loading the response message with the connection information (for example SDP and the like) contained in the proxy response request message to the caller terminal 1 of the call (step 83). In addition, it answers to the proxy response terminal 3 by storing the message information 99 of the call registered in the session control table 44 in the response message (step 84). And it sends a message of interrupting the call to the receiving terminal 2 (step 85). And it renews the calling state (98) and callee information (97) in the session control table 84 as shown by the example of 102 in FIG. 8.

Incidentally, the processing procedure from the steps 84 through 86 may be changed. Other processing of the call control program 42 not directly related with the processing of other proxy responses 42 is summarized in step 87.

This example of carrying out is described on the assumption that, when there are a plurality of incoming information in the calling state to be notified in the step 81, the incoming information of all the calls in the calling state is notified to the proxy response terminal 3. However, an item of managing the time of renewal of state may be added to the elements in the session control table 44, and the calls that entered into the calling state before others may be given priority in the order of notification. And another method of controlling the priority in the order of notification may be the addition of an item for weighting the users 92 among the elements of the terminals control table 43 in such a way that the higher position the user occupies the higher weight may be given so that the incoming call addressed to high-ranking officers may be given priority in the order of notification.

This example of carrying out is described on the assumption that each of the functional blocks shown by 40 through 48 in Table 3 is entirely executed by software processing. However, processors, signal processing circuits and the like corresponding respectively to the functional blocks may be used to realize by hardware the configuration shown in FIG. 3.

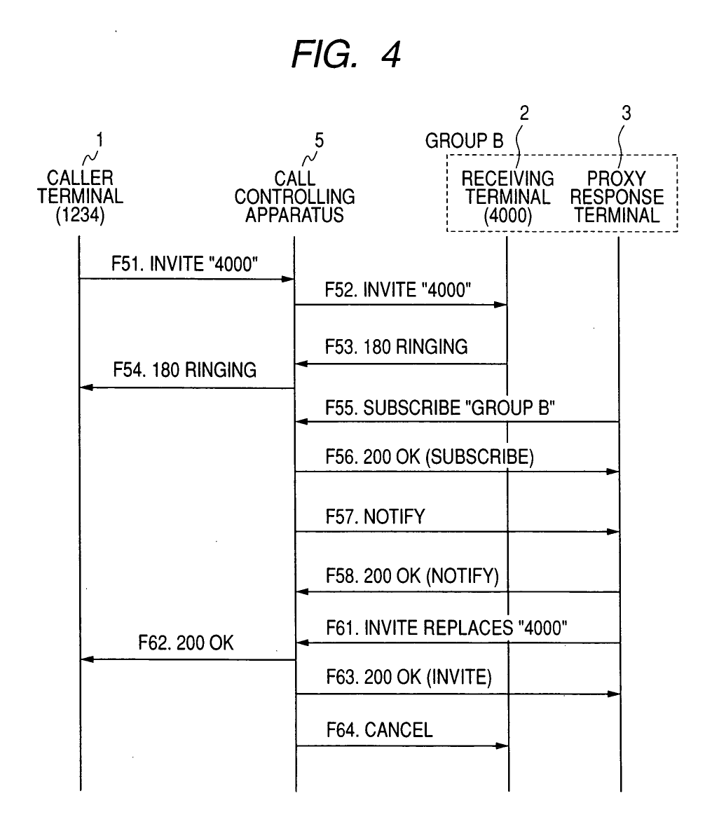

FIG. 4 is a sequence diagram showing an example of the connecting procedure at the time of proxy response. Here, the sequence that may be realized if SIP is used as the connection control protocol is taken up as an example. The transmission of an INVITE message to the receiving terminal 2 from the calling terminal 1 through the call control apparatus 5 (F51, F52) and the response of calling message from the receiving terminal 2 to the calling terminal 1 through the call control apparatus 5 (F53, F54) are similar to the prior SIP sequence.

For the incoming information acquisition request from the proxy response terminal 3 in the present invention, information on the state of terminals belonging to the group is used. In particular, SUBSCRIBE messages specifying the group as the address of request are sent as request message for the acquisition of information on the state of the group terminals in the calling state (F55). On the other hand, NOTIFY messages are used for the incoming information notice from the call control apparatus 5 (F57).

Then, in response to the proxy response request from the proxy response terminal 3, INVITE messages using the Replaces header defined in RFC3891 are used (F61). The call control apparatus 5 having received the message of F61 searches the session control table 44 by using the call identification ID (Call ID) specified in the Replaces header as a search key, and sends back a response message containing the SDP information of F61 to the calling terminal 1 of the call (F62) On the other hand, the message information 99 of the call registered in the session control table 44 loaded on the response message is sent back to the proxy response terminal 3 (F63). And a message of interrupting the call is sent out to the receiving terminal 2 (F64).

In the example of sequence shown in FIG. 4, the SUBSCRIBE message of F55 used as a Fetch-type message is issued after a call has occurred. However, the message may be issued in advance, and after the reception of the calling message of F53, the information may be notified by a NOTIFY message as shown by F57. However, in the case of using such a form of operation, even if no proxy response is required, the incoming call information may be notified to the terminal having made a prior request (SUBSCRIBE), and this may create a problem in terms of privacy. In such a case, the problem can be solved by introducing a presence server having the function of monitoring and notifying changes in the state and allowing the level of information disclosure to be set.

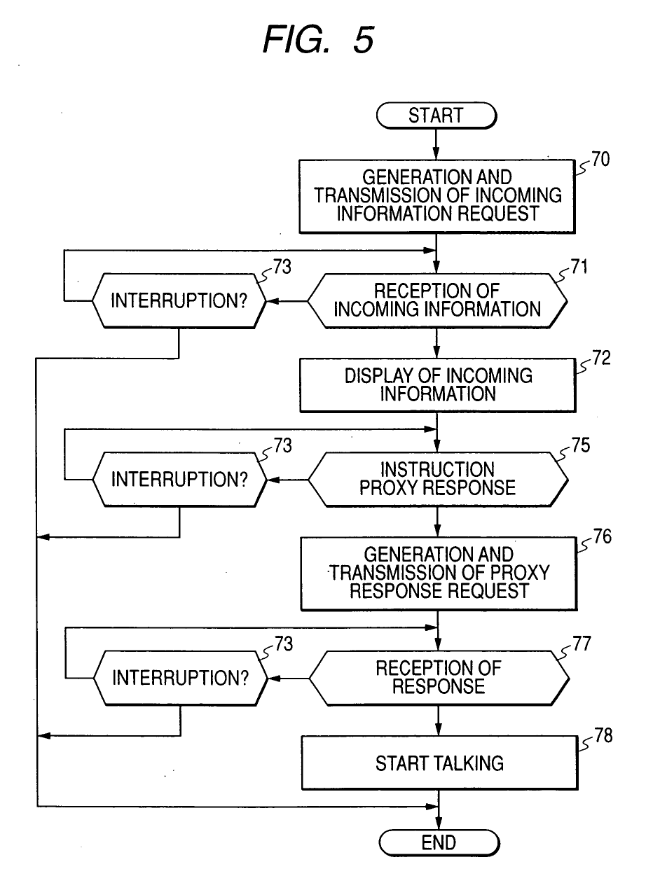

FIG. 5 is a flowchart showing an example of processing procedure at the time of proxy response in a proxy response terminal. When an acquisition request has been issued for information relating to messages received by the terminals within the group in the calling state as a result of an pressure applied on the proxy response button 107, an incoming information request is generated by the incoming information acquiring means 22 within the command generating unit 21, and the message is sent out to the call control apparatus 5 through the sending packet generating unit 11 and the communication controlling unit 10.

Upon receiving the incoming information through the communication control unit 10 and the incoming packet analyzing unit 21 (step 71), the incoming information is displayed on the display 19 through the display contents shaping unit 18 (step 72).

When a proxy response is executed by confirming the incoming information (step 75), a proxy response request is generated by the proxy response requesting means 23 and a message is sent out to the call control apparatus 5 through the sending packet generating unit 11 and the communication control unit 10 (step 76).

Upon receipt of a response message to the proxy response request through the communication control unit 10 and the incoming packet analyzing unit 21 (step 77), the process passes to the communication start state (step 78).

When a cancellation of operation such as on hook operation has occurred during the standby state for receiving message or the input of a command like step 71, step 75 and step 77 (step 73), the proxy response processing is interrupted.

In the example described above, the effect of carrying out a proxy response to an incoming message to the internal telephone apparatuses is described. However, the present invention displays the following effects in the case where the caller is an internal telephone apparatus and the callee is a cellular telephone used outside.

PBX and prior call control apparatus include devices wherein the transfer of calls during the absence of the user can be set. The use of such a device will enable the user to set the incoming message to the telephone apparatus on the user's desk to be transferred to a cellular telephone when the user is absent, or to set the call control apparatus to transfer the call to the representative number of the group or the telephone on the user's desk when the user cannot respond to the incoming call to the cellular phone (for example, when the cellular phone is out of reach of the electric wave or in the case of no response after repeated calls, and the like).

If the call control apparatus includes an incoming information notifying means of the present invention in a situation similar to the latter, it will be possible to inform the proxy responder that the primary address is the cellular phone. When anyone other than the owner of the cellular phone responds to the call to the cellular phone, the caller will be perplexed. However, when the proxy responder can realize in advance that he or she is responding to a call to the cellular phone, the proxy responder will be able to respond adequately.

The proxy response method of the present invention, which enables to acquire information relating to the calls in calling state, for example, information on who is calling who, can be applied as a telephone system of an organization wherein a plurality of telephone apparatuses are used and the proxy response is required to facilitate business.

What is claimed is:

1. A communication system, a plurality of terminal apparatuses and a call controlling apparatus for performing the relay control and the call state management of call control messages transmitted and received by and among various terminals being connected through a communication network,
wherein the terminal for making proxy response among the plurality of terminal apparatuses comprises an acquiring means of incoming information for requesting information relating to calls in the calling state from terminals within the group to which it belongs, and proxy response requesting means for issuing connection requests specifying the calls for proxy response to the call controlling apparatus,
wherein the call controlling apparatus comprises a incoming information notifying means for notifying the information relating to calls in calling state from the terminals within the group to which the terminal for carrying out the proxy response belong in response to the incoming information acquiring request from the terminal carrying out the proxy response, and call controlling means for handling the connection requests issued by the terminal having transmitted the calls and the proxy response requests made by the terminal for performing the proxy response as a call, and
wherein the terminals for performing the proxy response output the information about the caller and the callee on the user interface before making a proxy response.

2. The communication system according to claim 1, wherein, if there are a plurality of calls in the calling state at the same time, the call controlling apparatus provide the terminals carrying out the proxy response with information relating to all the calls now being made, and the terminals carrying out the proxy responses output all the information notified on the user interface, and accept the input for selecting the calls to which proxy responses will be made.

3. A terminal for making proxy responses connected with a plurality of terminal equipment and a call controlling apparatus for carrying out the relay control and the call state management of call control messages sent out and received by and between various terminals through a communication network,
wherein, upon receiving a command for acquiring incoming information from the user interface, the terminal sends a request message for the incoming information requesting information on the calls in the calling state at the terminals within the group to which the terminal belongs to the call controlling apparatus.

4. The terminal according to claim 3,
wherein, upon outputting the incoming information notified by the call controlling apparatus to the user interface and receiving a proxy response command for specifying the calls to which proxy response should be made from the user interface, the terminal transmits the request for proxy response specifying the call to the call controlling apparatuses.

5. A call controlling apparatus connected with a plurality of terminal apparatuses through a communication network,
wherein, upon receiving a request message for incoming information on terminals in the calling state from the proxy response terminal, the apparatus searches the calls of terminals of the group to which the terminal making the proxy response belongs having sent the message and in calling state, and notifies the information relating to the call to the terminal making the proxy response.

6. The call controlling apparatus according to claim 5,
wherein, upon receiving a proxy response request message specifying the terminal to which proxy responses should be made from among the terminals in calling state from the terminal making the proxy response, the apparatus controls the connection with each of the calling terminal of the specified call and the terminal making the proxy response, and treats a call established between the calling terminal and staid terminal making the proxy response as a call.
